(19) United States
(12) Patent Application Publication
(10) Pub. No.: US 2015/0227957 A1
(43) Pub. Date: Aug. 13, 2015

(54) MAXIMIZING CREDIT CARD REWARDS

(71) Applicant: International Business Machines Corporation, Armonk, NY (US)

(72) Inventors: Lisa M. Bradley, Cary, NC (US); Nan Li, Austin, TX (US); Charles E. Wiese, Raleigh, NC (US); Marissa A. Wood, Laguna Vista, TX (US)

(73) Assignee: International Business Machines Corporation, Armonk, NY (US)

(21) Appl. No.: 14/175,200

(22) Filed: Feb. 7, 2014

(51) Int. Cl. G06Q 30/02; G06Q 20/20; G06Q 20/34; G06Q 20/40; G06Q 20/10; G06Q 20/24

(52) U.S. Cl. CPC G06Q 30/0226; G06Q 20/102; G06Q 20/24; G06Q 20/34; G06Q 20/401; G06Q 20/204

(57) ABSTRACT

Embodiments of the present invention disclose a method, computer program product, and system for splitting credit card transactions. A computer receives a request to complete a credit card transaction from a point of sale device. The computer determines an optimal distribution of the credit card transaction across a plurality of payment sources. The computer divides the credit card transaction into a plurality of smaller credit card transactions, based at least in part on the optimal distribution of the credit card transaction, wherein each of the plurality of smaller credit card transactions corresponds to a payment source of the plurality of payment sources. The computer sends each of the plurality of smaller credit card transactions to the corresponding payment source for approval.

### FIELD OF THE INVENTION

The present invention relates generally to the field of financial transactions, and more particularly to maximizing credit card rewards.

### BACKGROUND OF THE INVENTION

Credit card transactions are increasingly common in the daily lives of millions of people worldwide. In addition to credit cards offered by traditional banking institutions and credit unions, individual merchants often offer credit cards for use exclusively at a particular business. Credit cards from various issuers typically have different characteristics and benefits. For example, credit cards may offer variable interest rates based on the type of use, amount of use, or location of use. Additionally, some credit cards offer rewards such as frequent flyer miles, cash back, or points, which can be redeemed for various benefits to the user. Smartcard technology enables consumers to store credit card information for multiple cards on a single credit card device. This allows consumers to carry and swipe a single card rather than having to manually select the desired card from the user's wallet. Some smart cards have the ability to automatically select which single credit card account to charge in any given transaction.

### SUMMARY

Embodiments of the present invention disclose a method, computer program product, and system for splitting credit card transactions. A computer receives a request to complete a credit card transaction from a point of sale device. The computer determines an optimal distribution of the credit card transaction across a plurality of payment sources. The computer divides the credit card transaction into a plurality of smaller credit card transactions, based at least in part on the optimal distribution of the credit card transaction, wherein each of the plurality of smaller credit card transactions corresponds to a payment source of the plurality of payment sources. The computer sends each of the plurality of smaller credit card transactions to the corresponding payment source for approval.

### BRIEF DESCRIPTION OF THE SEVERAL VIEWS OF THE DRAWINGS

FIG. 1 is a functional block diagram illustrating a credit card transaction processing environment, in accordance with an embodiment of the present invention.

FIG. 2 is a flowchart depicting operational steps of a payment splitting program on a server computer within the environment of FIG. 1, in accordance with an embodiment of the present invention.

FIG. 3 depicts a block diagram of components of the server computer executing the payment splitting program, in accordance with an embodiment of the present invention.

### DETAILED DESCRIPTION

Embodiments of the present invention recognize that, in order to maximize credit card benefits and rewards, a single credit transaction may ideally be processed as a set of smaller transactions spread across multiple payment accounts. Credit card users with multiple credit cards, each offering unique and diverse benefits and rewards, often desire to maximize their rewards according to their unique personal situations, but the historical requirement that each transaction be applied, in its entirety, to only one card can limit the card user's ability to recoup the maximum desired rewards.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk®, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

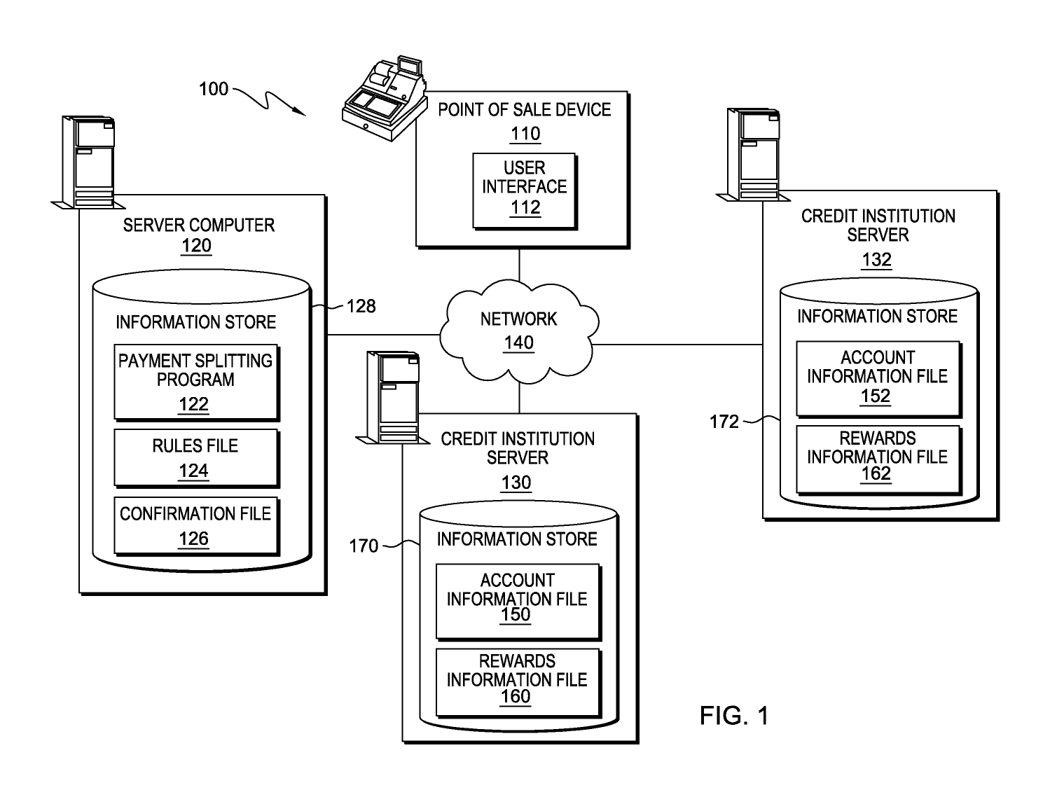

The present invention will now be described in detail with reference to the Figures. FIG. 1 is a functional block diagram illustrating a credit card transaction processing environment (“environment”), generally designated 100, in accordance with one embodiment of the present invention.

Environment 100 includes point of sale device 110, server computer 120, and credit institution servers 130 and 132, all interconnected over network 140. Network 140 can be, for example, a local area network (LAN), a wide area network (WAN) such as the Internet, or a combination of the two, and can include wired, wireless, or fiber optic connections. In general, network 140 can be any combination of connections and protocols that will support communications between point of sale device 110, credit institution servers 130 and 132, and server computer 120.

Point of sale device 110, credit institution servers 132 and 130, and server computer 120 may be a laptop computer, tablet computer, netbook computer, personal computer (PC), a desktop computer, a personal digital assistant (PDA), a smart phone, or any programmable electronic device capable of communicating via network 140. In an embodiment, point of sale device 110, credit institution servers 132 and 130, and/or server computer 120 is a computing system utilizing clustered computers to act as a single pool of seamless resources.

Point of sale device 110 is a computing device used to initiate and complete retail transactions. Point of sale device 110 can be, for example, an electronic cash register or an electronic funds transfer at a point of sale terminal. Point of sale device 110 includes user interface 112, which may be a scanner, touch screen, display, or any system that allows a user to interact with point of sale device 110. In an embodiment, user interface 112 includes a magnetic stripe reader for receiving credit card information from a credit card or smart card via a magnetic stripe located on the credit card or smart card. Point of sale device 110 can receive credit card information from a credit card, smart card, or a credit card holder with access to the information stored on a credit card. For example, a credit card holder can manually enter credit card information such as a credit card number, security code, expiration date, name of the card holder and/or card holder ZIP code. In an embodiment, point of sale device 110 receives scanned user credit card information (i.e., a user draws the magnetic stripe of the credit card through a magnetic stripe reader attached to point of sale device 110).

Point of sale device 110 can receive the user credit and/or debit card information through a direct electrical connection with the card using, for example, a Chip-and-PIN compliant connection. For example, if a customer wishes to pay for goods using this system, the card is placed into a swipe-card reader, such as point of sale device 110, which accesses the chip on the card. Once the card has been verified as authentic, the customer enters a personal identification number (“PIN”), which is submitted to the chip on the smartcard; if the two match, the chip tells the terminal, such as point of sale device 110, the PIN was correct, otherwise it informs it the PIN was incorrect.

Credit institution servers 130 and 132 are computing devices that are maintained by banking institutions or credit card issuers that have issued credit cards to the user who initiates the credit card transaction at point of sale device 110. Credit institution servers 130 and 132 include information stores 170 and 172 respectively. Information stores 170 and 172 include account files 150 and 152, respectively, and rewards information files 160 and 162, respectively. Credit institution servers 130 and 132 receive requests for approval of credit card charges associated with a specific account. Credit institution servers 130 and 132 compare the amount of the charge against the available credit associated with the card holder's account(s). If there is sufficient credit/funds available in the account, barring institutional policies which may otherwise prohibit such a transaction, credit institution servers 130 and 132 transmit a message denoting approval of the transaction to the location that requested the transaction approval, such as point of sale device 110 or computer server 120. If the account contains insufficient credit/funds, then credit institution servers 130 and 132 either reject the charge (i.e., decline the transaction) or accept the charge, but apply an overdraft charge to the account.

Account information files 150 and 152 are collections of information detailing the contents and identifying information of credit/debit accounts that the user maintains with the credit institutions associated with credit institution servers 130 and 132, respectively. Account information files 150 and 152 include identifying information regarding the account and associated credit/debit cards. For example, account information files 150 and 152 include information associating a card number with the relevant account so that when credit institution server 130 and/or 132 receives a request to execute a transaction with a card having a specified card number, the credit institution server can locate the correct account to process the transaction. Account information files 150 and 152 also include account balance information for the specified account. The account balance is a running total of the available credit/funds in the account. Credit institution servers 130 and 132 compare a received transaction amount to the account balance in order to determine whether or not to approve the transaction.

Rewards information files 160 and 162 include information detailing various rewards programs that apply to credit/debit accounts stored on credit institution servers 130 and/or 132. Payment splitting program 122 accesses rewards information files 160 and 162 via network 140 to determine an optimal distribution of divided transactions so that the user receives the maximum rewards for a given purchase. Rewards information files 160 and 162 can include, for example, information detailing cash back rewards, variable interest rate information, frequent flyer miles information, and/or reward points information. In various embodiments, the user can modify rewards information files 160 and 162 in order to specify which types of rewards the user prefers.

Server computer 120 is a computing device that facilitates the maximization of user credit/debit card rewards for retail transactions, in accordance with an embodiment of the present innovation. Server computer 120 includes payment splitting program 122, rules file 124, and confirmation file 126, all stored on information store 128. Payment splitting program 122 is a computer program that maximizes the credit/debit card reward points that a user receives for a retail transaction by dividing the transaction into a plurality of smaller transactions. Payment splitting program 122 can receive credit card transaction requests (“request”) from computing devices, such as point of sale device 110. Payment splitting program 122 can analyze requests to calculate and process sets of smaller credit card transactions (divided transactions), spread across multiple payment sources that maximize user credit/debit card reward points according to user preferences.

Payment splitting program 122 can divide single transactions into multiple smaller transactions based on an analysis of rewards information and user defined rules, and transmits, via network 140, requests for approval to credit institutions' financial transaction servers, such as credit institution servers 130 and 132, to which the divided transactions are intended. In one embodiment, payment splitting program 122 is stored on a server independent of point of sale device 110 and credit institution servers 130 and 132. In this embodiment, the credit card used to initiate the transaction can be a smart card that includes the credit card information for a plurality of credit card accounts belonging to the user. In another embodiment, payment splitting program 122 is a plug-in module that is incorporated into existing credit card transaction processing systems.

In various embodiments, server computer 120 represents a server in an existing financial transaction environment that executes financial transaction software designed to facilitate credit/debit transactions between point of sale devices, such as point of sale device 110, and credit institutions. The existing financial transaction environment can include a common software platform with the capability to receive instructions from point of sale devices and route those instructions to the appropriate credit institutions, such as those associated with credit institution servers 130 and 132. Such software can also provide standardized storage and representation of financial transaction data, common storage of transaction events for monitoring, and/or a unified development environment for integration of existing financial transaction hardware (i.e., point of sale device 110 and credit institution servers 130 and/or 132).

Rules file 124 includes a set of predetermined rules defining an algorithm that determines an optimal distribution of a financial transaction across multiple payment sources. In various embodiments, predetermined rules can include rules derived from institutional rewards information, as well as user defined rules. Institutional rewards information includes details regarding programs such as frequent flyer miles, points systems, and/or cash back. User defined rules include specific rules that a user submits to payment splitting program 122 for use in generating the optimal distribution, such as prioritizing one account over another. Rules file 124 can be stored in memory, such as information store 128 on server computer 120, or information stores 170 and/or 172 on credit institution servers 130 and/or 132, respectively, and accessed via network 140. In another embodiment, rewards information can be stored on the same computer system as payment splitting program 122 and accessed locally.

Confirmation file 126 is a computer readable file that instructs payment splitting program 122 to transmit a confirmatory message to point of sale device 110 in response to each of the credit institutions involved in processing the divided transactions accepting the charges, as determined by payment splitting program 122.

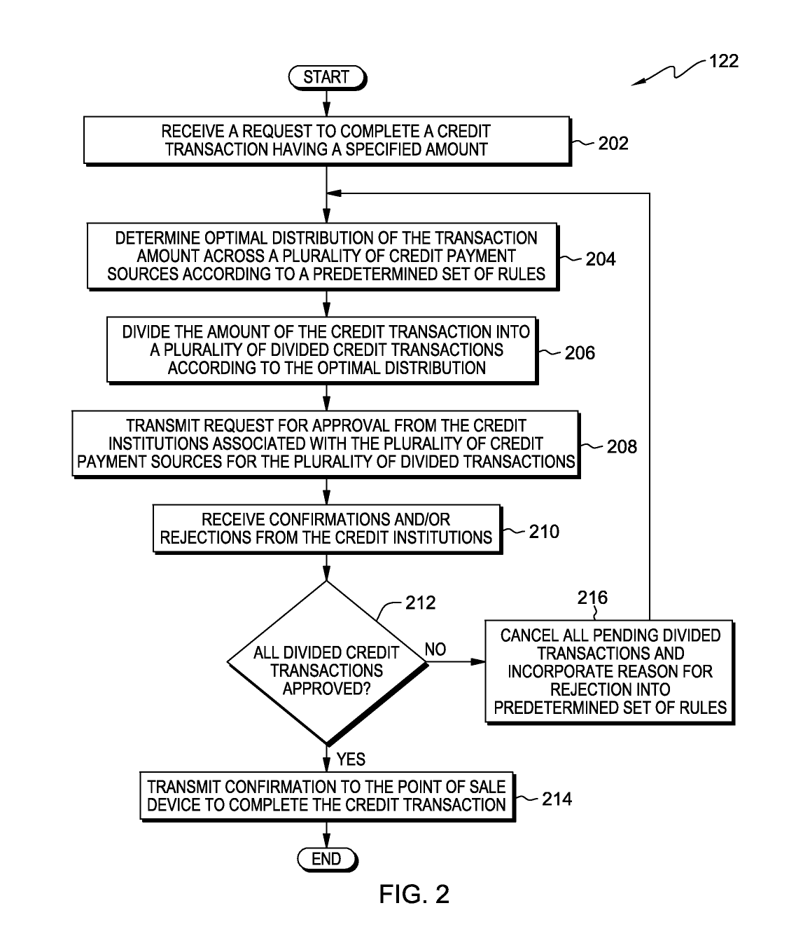

FIG. 2 is a flowchart depicting operational steps of payment splitting program 122, on server computer 120 within the environment of FIG. 1, in accordance with an embodiment of the present invention. To begin, a credit/debit card user (“user”) initiates a credit/debit card (“card”) transaction by, for example, swiping a credit card at point of sale device 110. In one embodiment, applicable credit cards include smart cards which store user information for multiple cards stored on a single card. For example, a single physical card connects to a cloud based computer server, where card information, such as card number, security code, expiration date, and the card holder's name is stored on the cloud based computer server. When the card user initiates a card transaction with the smart card at point of sale device 110, point of sale device transmits a request to complete the transaction to the cloud based computer server. The cloud based computer server selects one or more accounts to complete the transaction. In another embodiment, the smart card can have on-board memory included in an electrical circuit inside of the card, such as a cache memory or RAM, as part of an integrated circuit. Point of sale device 110 receives, via user interface 112, user information from the card and transmits, via network 140, a request to payment splitting program 122. The card includes information regarding the location (e.g., the IP address) of the computer server to which point of sale device 110 transmits a request for approval. Where the card is associated with a single credit institution, the computer server is a credit institution server such as credit institution servers 130 and 132. Where the card includes multiple accounts on a single physical card, the information stored on the physical card instructs point of sale device 110 to transmit the request to a server, such as server computer 120, which serves as an intermediary for communication between point of sale device 110 and credit institution servers 130 and 132.

Payment splitting program 122 receives a request to complete a financial transaction having a specified amount (step 202). For example, the user has cards issued by credit institutions associated with credit institution server 130 and credit institution server 132. The user, via user interface 112, swipes a card issued by a credit institution associated with credit institution server 130, and in response, point of sale device 110 transmits, via network 140, a financial transaction approval request of initiated transaction to server computer 120. Payment splitting program 122, which resides on server computer 120, receives the request and accesses, via network 140, account information files 150 and 152 and rewards information files 160 and 162 associated with the user on credit institution server 130 and credit institution server 132 respectively.

Payment splitting program 122 determines the optimal distribution of the transaction amount across a plurality of credit payment sources according to a predetermined set of rules (step 204). Payment splitting program 122 accesses account information files 150 and 152, rewards information files 160 and 162, and rules file 124 to calculate the optimal distribution. Based on the information in those files and the information included in the request from point of sale device 110, payment splitting program 122 generates a distribution of payments that will maximize the amount of rewards that the user will receive following the transaction within the boundaries established by rules contained in rules file 124. Payment splitting program takes into account the amount of the transaction, the various rewards programs stored in rewards information files 130 and 132, and any preferences that the user manually submitted indicating preferences of one type of rewards over another. For example, payment splitting program 122 accesses the rewards information files for each of the credit payment sources associated with the user. In an embodiment, those rewards information files may be stored on credit institution servers 130 and/or 132. In other embodiments, those rewards information files may be stored on server computer 120. In another embodiment, the information can be manually entered into payment splitting program 122 by the credit card user via user interface 112.

In another embodiment, the user manually enters specific rules into rules file 124 that constrain the possible distributions of the transaction amount among the various credit accounts. For example, a user can decide that a particular credit card should be prioritized over another for certain types of charges (e.g., groceries, gas, restaurants). In this example, payment splitting program 122 assigns a larger portion of the transaction amount to the prioritized account than if the user had not made the rule. In one embodiment, point of sale device 120 transmits transaction information, such as the location and/or type of charge, to payment splitting program 122. Payment splitting program 122 determines the optimal distribution of the transaction amount based on, for example, user defined rules and information regarding the user's various credit card accounts contained in rules file 124, such as benefits and rewards programs available on those accounts, information about the merchant (e.g., location and type), and/or whether any of the user's credit card accounts is associated with the merchant. In one embodiment, payment splitting program 122 transmits a request to credit institution servers 130 and 132 for information detailing rewards information for credit/debit accounts associated with the user. In an embodiment, the user may specify rules to be applied when payment splitting program 122 calculates the optimal distribution. In one embodiment, the user submits rules through a computing system connected to server computer 120, on which rules file 124 can reside, via network 140. For example, a smart phone application configured to receive user defined rules can reside on a smart phone and connect to server computer 120 via network 140 to transmit a set of user defined rules to computer 120 for use by payment splitting program 122.

In one embodiment, payment splitting program 122 takes into account card restrictions. For example, if a particular card retains a lower interest rate if it is used enough times in a single month, then payment splitting program 122 can create a specific rule that indicates that a particular account should be prioritized over others in order to ensure that a sufficient number of transactions are completed to acquire the lower interest rate. In one embodiment, payment splitting program 122 periodically refreshes the predetermined set of rules in order to maintain accurate rules for determining the optimal distribution of charges. For example, each day, payment splitting program 122 checks the balance of each credit card account in order to generate a new maximum charge amount for each credit card. In another embodiment, payment splitting program 122 refreshes the balance of each account and the active rewards and benefits available to the card holder any time payment splitting program 122 generates a new optimal distribution.

Payment splitting program 122 divides the amount of the credit/debit transaction (“transaction”) into a plurality of divided credit transactions according to the optimal distribution determined in step 204 (step 206). For example, payment splitting program 122 divides the amount of the transaction into smaller charges. The amount of each divided charges is determined by the optimal distribution of the charges across the payment sources that was determined in step 204. When added together, the smaller charges must add up to the exact amount of the initial credit transaction. For example, if a user is purchasing items totaling $9.99, payment splitting program 122 determines the number of possible payment sources, such as credit institution server 130 and credit institution server 132, and that the optimal distribution is for two-thirds (⅔) of the payment to go to credit institution server 130 and the remaining third (⅓) to go to credit institution server 132. In response, payment splitting program 122 divides the single $9.99 charge in to one charge of $6.66 and one charge of $3.33.

TABLE 1

| Credit | | Locations/ | User defined |
|---|---|---|---|
| Card | Reward type | eligible items | restrictions |
| Upromise | Automatically | Grocery items | Max limit $3,000 |
| Card | contributes to her | Gas stations | No minimum |
| | child's college | A & B | purchases/month |
| | account on | Restaurants | |
| | eligible purchases | C & D | |
| | from grocery | | |
| | stores, online re- | | |
| | tailers, travel, | | |
| | restaurants and | | |
| | gas stations | | |
| | APR 13.5% | | |
| Debit | Earn 2.51% APY | All purchases | Limit bank account |
| Card | when used thirty | | No overdraft |
| | (30) or more | | Want to use on ex- |
| | times each month | | penses less than $20 |
| | No APR | | Never use on expenses |
| | | | greater than $100 |
| | | | Need 30 purchases per |
| | | | month |
| Basic | Reward points | All purchases | Max limit $5,000 |
| Visa | toward purchases | Special deals at | No minimum |
| | of items | times were there | purchases/month |
| | APR 9.5% | are additional | Use for all other |
| | | rewards for cer- | purchases greater than |
| | | tain items and/or | $20 and not matching |
| | | stores | items from Upromise |
| | | | Card |

Table 1 provides an example of different credit/debit cards, reward types, locations/eligible items, and user defined restrictions that may be stored in rewards information files 160, 162 and/or rules file 124. Payment splitting program 122 determines the amount and type of purchase requested at point of sale device 110. Payment splitting program then divides the transaction into a plurality of divided transactions so that each of the divided transactions conform to the rules enumerated in Table 1. For example, a requested purchase for groceries that total over $100 may be split into two smaller transactions. One transaction can be less than $20 and charged to the debit card so that the user gains a charge toward the monthly goal of 30 transactions. The second transaction represents the remainder of the transaction and charges to the Upromise card in order to contribute funds to the user's child's college fund. In the event that the Upromise card is at its maximum balance of $3,000, payment splitting program generates a third payment to charge the balance of the original transaction that cannot be covered by the Upromise card or the Debit card to the Visa card in order to receive rewards points.

In another embodiment, transaction items may be divided among payments according to purchase type. For example, if payment splitting program 122 determines that the user has a card associated with credit institution server 130 that receives reward points for food purchases, but those purchases do not apply to nonperishable items, and another card associated with credit institution server 132 that has a lower interest rate than the first card account, then payment splitting program 122 divides the amount into two categories, “food” and “nonperishable”, according to the optimal distribution determined in step 204 and based on item information received from point of sale device 110. Hence, payment splitting program 122 charges the food items to the card that is associated with credit institution server 130 that has reward points for grocery purchases and charges the nonperishable items to the card that is associated with credit institution server 132 that has the lower overall interest rate. As one of skill in the art will appreciate, end consumer merchants typically transfer information regarding the type(s) of item(s) purchased in a credit/debit transaction.

Payment splitting program 122 transmits a request for approval to the credit institutions associated with the plurality of credit payment sources for the plurality of divided transactions (step 208). For example, payment splitting program 122 transmits a request for approval via network 140 to credit institution servers 130 and 132 using the same message format and protocol as the request that payment splitting program 122 received from point of sale device 110. For example, payment splitting program 122 sends a request for approval of a $6.66 charge on the first credit account to credit institution server 130 and payment splitting program 122 sends a request for approval of a $3.33 charge to credit institution server 132.

Payment splitting program 122 receives confirmations and/or rejections from the credit institutions (step 210). Credit institutions that are associated with credit institution servers 130 and 132 review the charge amounts associated with the request and compare the amounts with the user's available credit/funds. If sufficient credit/funds exist, then the credit institution accepts the charges and transmits an approval notification back to payment splitting program 122. If there is not sufficient credit, then the credit institution transmits a decline charge response to payment splitting program 122 along with the reasons for the rejection.

Payment splitting program 122 determines whether all divided transactions are approved (decision block 212). If payment splitting program 122 determines that less than all of the divided credit transactions are approved (decision block 212, NO branch), then payment splitting program 122 cancels all pending divided transactions and incorporates the reason(s) thereof into the predetermined optimization rules in step 216. In other embodiments, in response to the above, payment splitting program 122 cancels all pending divided transactions because each divided transaction must receive approval in order to ensure that the total amount charged to the card matches the original transaction amount generated at point of sale device 110. In certain embodiments, payment splitting program 122 incorporates the rejection reasons into rules file 124 to reduce the chances of receiving the same rejections. For example, if credit institution 132 rejects the $3.33 payment discussed above because the user has insufficient credit/funds of $3.00 available, then a rule “do not charge more than $3.00 to credit institution 132” is incorporated into the predetermined set of rules. Here, subsequent to canceling all pending divided transactions and updating rules file 124, payment splitting program 122 returns to step 204.

If payment splitting program 122 determines that all of the credit institutions approved the divided transactions (decision block 212, YES branch), then payment splitting program 122 transmits a confirmation to point of sale device 110 to complete the credit transaction (step 214). Payment splitting program 122 can receive responses from the credit institution servers and, upon confirming that all credit institutions have approved the divided transactions, sends a confirmation message denoting approval of the transaction to point of sale device 110. For example, payment splitting program 122 accesses confirmation file 126, determines that all credit institutions that are associated with the request approved the divided transactions, and transmits a single confirmation to point of sale device 110 via network 140.

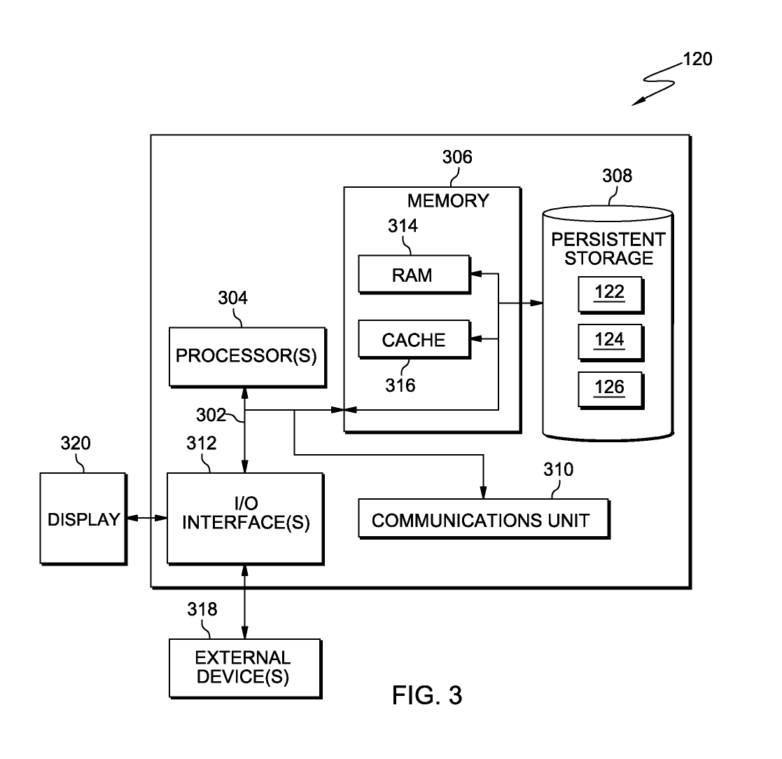

FIG. 3 depicts a block diagram of components of server computer 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made.

Server computer 120 includes communications fabric 302, which provides communications between computer processor(s) 304, memory 306, persistent storage 308, communications unit 310, and input/output (I/O) interface(s) 312. Communications fabric 302 can be implemented with any architecture designed for passing data and/or control information between processors (such as microprocessors, communications and network processors, etc.), system memory, peripheral devices, and any other hardware components within a system. For example, communications fabric 302 can be implemented with one or more buses.

Memory 306 and persistent storage 308 are computer-readable storage media. In this embodiment, memory 306 includes random access memory (RAM) 314 and cache memory 316. In general, memory 306 can include any suitable volatile or non-volatile computer-readable storage media.

Payment splitting program 122, rules file 124, and confirmation file 126 are stored in persistent storage 308 for execution by one or more of the respective computer processors 304 via one or more memories of memory 306. In this embodiment, persistent storage 308 includes a magnetic hard disk drive. Alternatively, or in addition to a magnetic hard disk drive, persistent storage 308 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 308 may also be removable. For example, a removable hard drive may be used for persistent storage 308. Other examples include optical and magnetic disks, thumb drives, and smart cards that are inserted into a drive for transfer onto another computer-readable storage medium that is also part of persistent storage 308.

Communications unit 310, in these examples, provides for communications with other data processing systems or devices, including point of sale device 110 and credit institutions 130 and 132. In these examples, communications unit 310 includes one or more network interface cards. Communications unit 310 may provide communications through the use of either or both physical and wireless communications links. Payment splitting program 122, rules file 124, and confirmation file 126 may be downloaded to persistent storage 308 through communications unit 310.

I/O interface(s) 312 allows for input and output of data with other devices that may be connected to server computer 120. For example, I/O interface 312 may provide a connection to external devices 318 such as a keyboard, keypad, a touch screen, and/or some other suitable input device. External devices 318 can also include portable computer-readable storage media such as, for example, thumb drives, portable optical or magnetic disks, and memory cards. Software and data used to practice embodiments of the present invention, e.g., payment splitting program 122, rules file 124, and confirmation file 126, can be stored on such portable computer-readable storage media and can be loaded onto persistent storage 308 via I/O interface(s) 312. I/O interface(s) 312 also connect to a display 320.

Display 320 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus, the invention should not be limited to use solely in any specific application identified and/or implied by such nomenclature.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for splitting credit card transactions, the method comprising:
receiving, by one or more computer processors, a request to complete a credit card transaction from a point of sale device;
determining, by one or more computer processors, an optimal distribution of the credit card transaction across a plurality of payment sources;
dividing, by one or more computer processors, the credit card transaction into a plurality of smaller credit card transactions, based at least in part on the optimal distribution of the credit card transaction, wherein each of the plurality of smaller credit card transactions corresponds to a payment source of the plurality of payment sources; and
sending, by one or more computer processors, each of the plurality of smaller credit card transactions to the corresponding payment source for approval.

2. The method of claim 1, wherein the optimal distribution of the credit card transaction is determined, at least in part, by a predetermined set of transaction rules.

3. The method of claim 2, further comprising:
receiving, by one or more computer processors, a plurality of responses from the plurality of payment sources;
determining, by one or more computer processors, that at least one of the plurality of payment sources declined at least one of the plurality of smaller credit card transactions; and
updating, by one or more computer processors, the set of transaction rules based, at least in part, on the reason for the at least one declined smaller credit card transaction.

4. The method of claim 3, further comprising:
canceling, by one or more computer processors, the plurality of smaller credit card transactions; and
determining a second optimal distribution of the credit card transaction across the plurality of payment sources based, at least in part, on the updated set of transactional rules.

5. The method of claim 2, further comprising:
receiving, by one or more computer processors, a plurality of responses from the plurality of payment sources;
determining, by one or more computer processors, that each of the plurality of payment sources approved the plurality of smaller credit card transactions; and
sending, by one or more computer processors, a confirmation message to the point of sale device instructing the point of sale device to complete the credit card transaction.

6. The method of claim 1, wherein the predetermined set of transaction rules includes at least credit card rewards.

7. The method of claim 1, wherein the predetermined set of transaction rules includes at least a set of user-defined rules.

8. A computer program product for splitting credit card transactions, the computer program product comprising:
one or more computer-readable storage media and program instructions stored on the one or more computer-readable storage media, the program instructions comprising:
program instructions to receive a request to complete a credit card transaction from a point of sale device;
program instructions to determine an optimal distribution of the credit card transaction across a plurality of payment sources;
program instructions to divide the credit card transaction into a plurality of smaller credit card transactions, based at least in part on the optimal distribution of the credit card transaction, wherein each of the plurality of smaller credit card transactions corresponds to a payment source of the plurality of payment sources; and
program instructions to send each of the plurality of smaller credit card transactions to the corresponding payment source for approval.

9. The computer program product of claim 8, wherein the optimal distribution of the credit card transaction is determined, at least in part, by a predetermined set of transaction rules.

10. The computer program product of claim 9, further comprising:
program instructions to receive a plurality of responses from the plurality of payment sources;
program instructions to determine that at least one of the plurality of payment sources declined at least one of the plurality of smaller credit card transactions; and
program instructions to update the set of transaction rules based, at least in part, on the reason for the at least one declined smaller credit card transaction.

11. The computer program product of claim 10, further comprising:
program instructions to cancel the plurality of smaller credit card transactions; and
program instructions to determine a second optimal distribution of the credit card transaction across the plurality of payment sources based, at least in part, on the updated set of transactional rules.

12. The computer program product of claim 8, further comprising:
program instructions to receive a plurality of responses from the plurality of payment sources;
program instructions to determine that each of the plurality of payment sources approved the plurality of smaller credit card transactions; and
program instructions to send a confirmation message to the point of sale device instructing the point of sale device to complete the credit card transaction.

13. The computer program product of claim 8, wherein the predetermined set of transaction rules includes at least credit card rewards.

14. The computer program product of claim 8, wherein the predetermined set of transaction rules includes at least a set of user-defined rules.

15. A computer system for splitting credit card transactions, the computer system comprising:
one or more computer processors;
one or more computer-readable storage media;
program instructions stored on the computer-readable storage media for execution by at least one of the one or more processors, the program instructions comprising:
program instructions to receive a request to complete a credit card transaction from a point of sale device;
program instructions to determine an optimal distribution of the credit card transaction across a plurality of payment sources;
program instructions to divide the credit card transaction into a plurality of smaller credit card transactions, based at least in part on the optimal distribution of the credit card transaction, wherein each of the plurality of smaller credit card transactions corresponds to a payment source of the plurality of payment sources; and
program instructions to send each of the plurality of smaller credit card transactions to the corresponding payment source for approval.

16. The computer system of claim 15, wherein the optimal distribution of the credit card transaction is determined, at least in part, by a predetermined set of transaction rules.

17. The computer system of claim 16, further comprising:
program instructions to receive a plurality of responses from the plurality of payment sources;
program instructions to determine that at least one of the plurality of payment sources declined at least one of the plurality of smaller credit card transactions; and
program instructions to update the set of transaction rules based, at least in part, on the reason for the at least one declined smaller credit card transaction.

18. The computer system of claim 17, further comprising:
program instructions to cancel the plurality of smaller credit card transactions; and
program instructions to determine a second optimal distribution of the credit card transaction across the plurality of payment sources based, at least in part, on the updated set of transactional rules.

19. The computer system of claim 15, further comprising:
program instructions to receive a plurality of responses from the plurality of payment sources;
program instructions to determine that each of the plurality of payment sources approved the plurality of smaller credit card transactions; and
program instructions to send a confirmation message to the point of sale device instructing the point of sale device to complete the credit card transaction.

20. The computer system of claim 15, wherein the predetermined set of transaction rules includes at least credit card rewards.
